(19) United States
(12) Patent Application Publication
(10) Pub. No.: US 2025/0118510 A1
(43) Pub. Date: Apr. 10, 2025

(54) MEDIUM-VOLTAGE VACUUM CIRCUIT BREAKER

(71) Applicant: ABB Schweiz AG, Baden (CH)

(72) Inventors: Felix Boy, Heidelberg (DE); Ondrej Frantisek, Heddesheim (DE); Ståle Talmo, Skien (NO); Marie Grue, Skien (NO); Magnus Nilsen, Skien (NO)

(21) Appl. No.: 18/897,367

(22) Filed: Sep. 26, 2024

(30) Foreign Application Priority Data
Oct. 4, 2023 (EP) 23201568.5

(51) Int. Cl. H01H 33/666; H01H 33/662

(52) U.S. Cl. CPC H01H 33/666; H01H 33/66207; H01H 2033/6667

(57) ABSTRACT

A medium-voltage vacuum circuit breaker, including a rotatable drive shaft, a vacuum interrupter unit and a linkage mechanism linking the drive shaft to the vacuum interrupter unit.

### TECHNICAL FIELD

The present disclosure relates to a circuit breaker, in particular a medium-voltage circuit breaker, more particularly a medium-voltage vacuum circuit breaker, and even more particularly a medium-voltage vacuum circuit breaker with a linkage mechanism.

### BACKGROUND

A circuit breaker is a switching device which performs a protective function against failures occurring in an associated electric circuit. A circuit breaker can be actuated, in a make operation to a closed position in which the circuit breaker allows a current flowing between two parts of the associated electric circuit, and in a break operation to an open position in which the circuit breaker interrupts such current flowing. In particular, a circuit breakers may be used for interrupting fault currents, e.g. an overload or short-circuit current.

A circuit breaker includes at least one interrupter unit that typically includes a movable contact and a stationary contact. The actuation of a circuit breaker typically involves a mechanism to move the movable contact between the closed position where the movable contact and the stationary contact are in contact, and the open position where the movable contact and the stationary contact are spaced apart from each other.

In a vacuum circuit breaker, the arc extinguishing medium and the insulating medium of the contact gap after the arc is extinguished is vacuum. The arc extinguishing medium and the insulating medium of the contact gap is often contained within the one or more interrupter unit of the circuit breaker. Vacuum circuit breaker are often used in distribution networks. It may be understood that a circuit breaker is required to safely and reliably complete making and breaking operations that typically involve forces in the range of kilo-newtons, in a timeframe in the range of milliseconds. Accordingly, demanding performance and reliability specifications are placed on the mechanism(s) that move the movable contact, including any linkage mechanism that transmit and/or transform movements to the movable contact.

Furthermore, a circuit breaker is typically required to fit within specific dimensional limits. Accordingly, the mechanism(s) of the circuit breaker is additionally confronted with challenging space constraints, in addition to the performance and reliability specifications.

In view thereof, there is a need in the art for a circuit breaker that is compact, reliable and safe.

### SUMMARY

In view of the current needs, an object of the present invention is to provide a circuit breaker, in particular a circuit breaker with a linkage mechanism, that is compact, reliable and safe.

For providing a brief description of the invention, aspects of the invention are described as follows.

According to an aspect, there is presented a medium-voltage vacuum circuit breaker. The medium-voltage vacuum circuit breaker comprises a rotatable drive shaft, a vacuum interrupter unit and a linkage mechanism linking the drive shaft to the vacuum interrupter unit. The vacuum interrupter unit comprises a movable contact and a stationary contact, the movable contact being movable between a closed position and an open position along an axis of the movable contact and comprising a movable contact stem. The linkage mechanism comprises at least two rigid links including an upstream link and a downstream link rotatably coupled to each other via an upstream joint, the linkage mechanism being configured to be driven by the drive shaft and to transform a rotational movement of the drive shaft to a linear movement of the movable contact along the axis of the movable contact via at least the upstream link, the upstream joint and the downstream link. The linkage mechanism is configured to move towards a kinematic singularity position as the movable contact approaches the closed position during a closing operation. The kinematic singularity position of the linkage mechanism is defined by an angle of the upstream joint being 0 degrees, the angle of the upstream joint being between the upstream link and the downstream link. The drive shaft is arranged as a stopper for the linkage mechanism, obstructing the linkage mechanism from reaching the kinematic singularity position during the closing operation.

Beneficially, a compact, reliable and safe circuit breaker with a linkage mechanism is provided.

Further aspects, embodiments and examples, and benefits thereof may be further understood from the detailed description, in reference to the accompanying drawings, which are briefly described as follows.

### BRIEF DESCRIPTION OF THE DRAWINGS

Aspects, embodiments and examples, and benefits thereof of the invention shall emerge more clearly from the detailed description, which is illustrated by way of example and without limitation with the aid of the accompany drawings, in which:

FIG. 1 shows a circuit breaker with a linkage mechanism according to aspects and embodiments described herein;

FIG. 2 shows the linkage mechanism when the movable contact is in the open position as described herein;

FIG. 3 shows the linkage mechanism when the movable contact is in the closed position as described herein;

FIG. 4 shows a drive shaft arranged to act as a stopper for a linkage mechanism as described herein;

FIGS. 5A and 5B show the linkage mechanism in a position nearer to the open position as described herein;

FIGS. 6A and 6B show the linkage mechanism in a position nearer to the closed position as described herein;

FIG. 7 shows a drive mechanism when the movable contact is in the open position as described herein;

FIG. 8 shows the drive mechanism when the movable contact is in the closed position as described herein;

FIG. 9 shows the drive shaft arranged to act as a stopper for the drive mechanism as described herein;

FIG. 10 shows a further example of a linkage mechanism as described herein.

### DETAILED DESCRIPTION

Reference will now be made in more detail to the various aspects and embodiments, one or more examples of which are illustrated in each drawing. Within the following detailed description, the same reference numbers refer to the same or similar components. The reference numbers used in the drawings are merely for illustration.

Unless specified otherwise, features illustrated or described as part of one embodiment can be used individually or in conjunction with any other embodiment. The description of a part or aspect in one embodiment applies to a corresponding part or aspect in another embodiment as well, and any aspect described can be combined with any other aspect or embodiment described herein, unless specified otherwise. Each example is provided by way of explanation and is not meant as a limitation. Generally, only the differences with respect to the individual embodiments are described.

### Circuit Breaker and Linkage Mechanism

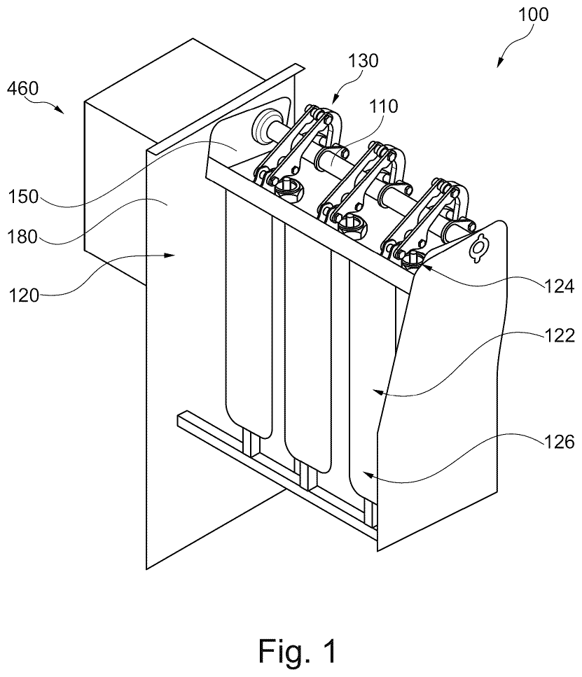

FIG. 1 shows a circuit breaker with a linkage mechanism according to aspects and embodiments described herein.

According to an aspect, a medium-voltage vacuum circuit breaker includes a rotatable drive shaft 110, a vacuum interrupter unit 120, and a linkage mechanism 130 linking the drive shaft 110 to the vacuum interrupter unit 120.

According to the aspect, the vacuum interrupter unit 120 includes a movable contact 122 and a stationary contact 126, the movable contact 122 being movable between a closed position and an open position along an axis of the movable contact and comprising a movable contact stem 124.

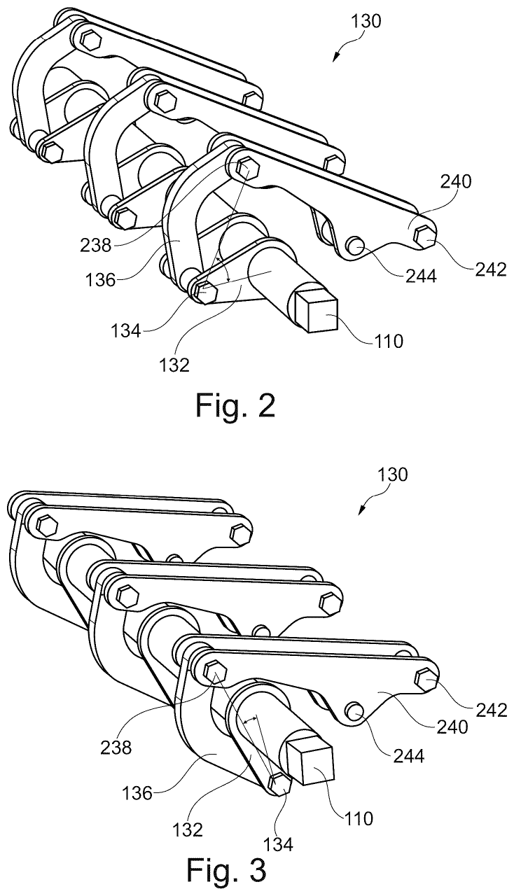

FIGS. 2 and 3 show the linkage mechanism, specifically, when the movable contact is in the open position and in the closed position respectively, according to aspects and embodiments described herein.

According to the aspect, the linkage mechanism 130 includes at least two rigid links including an upstream link 132 and a downstream link 136 rotatably coupled to each other via an upstream joint 134, the linkage mechanism 130 being configured to be driven by the drive shaft 110 and to transform a rotational movement of the drive shaft 110 to a linear movement of the movable contact 122 along the axis of the movable contact 122 via at least the upstream link 132, the upstream joint 134 and the downstream link 136.

According to the aspect, the linkage mechanism 130 is configured to move towards a kinematic singularity position as the movable contact 122 approaches the closed position during a closing operation, the kinematic singularity position of the linkage mechanism 130 being defined by an angle of the upstream joint 134 being 0 degrees, the angle of the upstream joint 134 being between the upstream link 132 and the downstream link 136.

Beneficially, due to the linkage mechanism moving towards a kinematic singularity as the movable contact approaches the closed position, the distribution of reaction forces in the linkage mechanism, in particular on the drive shaft, becomes increasingly of bending force and decreasingly of torque.

In general, reaction torque is held by some mechanism, typically a latching mechanism. Therefore, a reduced reaction torque provides great benefits with respect to wear on the mechanism.

Beneficially, the linkage mechanism is more capable of withstanding large static stresses and has correspondingly reduced wear, specifically in the closed position, which is the position the movable contact is in typically during operation of the circuit breaker.

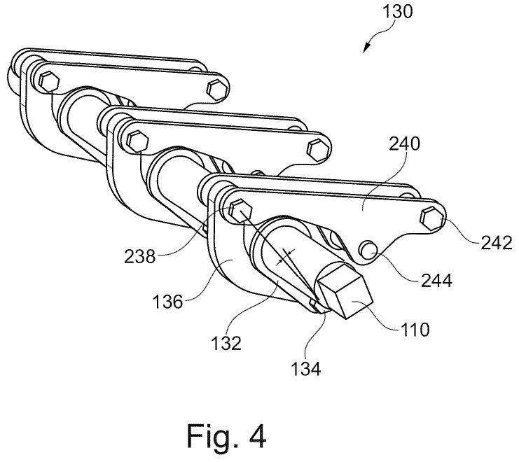

FIG. 4 shows the drive shaft arranged to act as a stopper for the linkage mechanism, according to aspects and embodiments described herein.

According to the aspect, the drive shaft 110 is arranged as a stopper for the linkage mechanism 130, obstructing the linkage mechanism 130 from reaching the kinematic singularity position during the closing operation.

Beneficially, as the drive shaft itself obstructs the linkage mechanism from reaching the kinematic singularity position, the linkage mechanism is prevented from moving through the kinematic singularity position and becoming destroyed and/or stuck.

In combination with configuring the linkage mechanism to move towards kinematic singularity, whereby static wear is greatly reduced and the circuit breaker is safer and more reliable, using the drive shaft to prevent the linkage mechanism from moving through the kinematic singularity results in a much safer and much more reliable mechanism that handles large dynamic forces during movement towards the kinematic singularity.

That is, the safe and reliable benefit is greatly compounded by the combination of both moving towards kinematic singularity and the drive shaft arranged as a stopper for the linkage mechanism.

Moreover, the drive shaft being arranged as a stopper for the linkage mechanism is particularly space efficient and simple, as the linkage mechanism itself obstructs itself from reaching the kinematic singularity position.

Beneficially, the linkage mechanism is safe and reliable without increased complexity and increased number of components, particularly when high forces (e.g. 1 to 100 kN) and fast switching (e.g. 1 to 1000 ms) occurs during closing.

### Upstream Joint and Angle of Upstream Joint

The angle of the upstream joint 134 may be understood as an angle between a first line extending perpendicularly to a rotation axis of the drive shaft 110 (and/or perpendicularly to a rotation axis of the upstream joint 134) from the upstream joint 134 to the drive shaft 110 and a second line extending perpendicularly to the rotation axis of the drive shaft 110 (and/or perpendicularly to a rotation axis of the upstream joint 134) from the upstream joint 134 to the downstream joint 238.

In an embodiment, the downstream joint 238 is arranged on the downstream link 136 and/or operably couples a motion of the downstream link 136 to a motion of the movable contact 122.

The angle of the upstream joint 134 may be understood as an angle in a plane perpendicular to the rotation axis of the upstream joint 134 and/or a plane perpendicular to the rotation axis of the drive shaft 110.

The angle of the upstream joint 134 may be understood to be an angle between a first line joining the upstream joint 134 and the downstream joint 238, and a second line joining the upstream joint 134 and the drive shaft 110 for example at a point of coupling of the drive shaft 110 with the upstream link 132.

The angle of the upstream joint 134 may be understood to be an angle between a first radially extending line and a second radially extending line, the first radially extending line extending from a centre of the upstream joint 134 to a centre of the drive shaft 110 and the second radially extending line radially extending from a centre of the upstream joint 134 to a centre of the downstream joint 238.

### Kinematic Singularity Position

The linkage mechanism 130 may be understood to be in the kinematic singularity position when the first line and the second line are collinear and/or when an angle of the upstream joint 134 is 0 degrees.

A kinematic singularity position of the linkage mechanism 130 may be understood to correspond to a maximum in the ratio of (transmittable/transmitting) torque in the drive shaft 110 to angular velocity of the upstream joint 134.

In a particular example, a kinematic singularity position of the linkage mechanism 130 may be understood to correspond to a minimum portion in the ratio of a torque (transmittable/transmitted) by the upstream link 132 on the drive shaft 110 to a bending force by the upstream link 132 on the drive shaft 110.

It may be understood that a kinematic singularity position of the linkage mechanism is described herein for supporting understanding of what is prevented, and the kinematic singularity position is not actually reachable by the linkage mechanism as described herein, due to the linkage mechanism being obstructed (by the drive shaft) from reaching the kinematic singularity position.

### Upstream Link and Downstream Link

In an embodiment, the upstream link 132 is a lever coupled in a non-rotatable manner to the drive shaft 110 at an upstream end portion of the upstream link 132. An upstream end portion of the upstream link 132 may be understood to be an end portion of the upstream link 132 closer or closest (in the kinematic chain and/or relative to the downstream end portion) to the drive shaft 110.

In an embodiment, the upstream link 132 is rotatably coupled via the upstream joint 134 to the downstream link 136 at a downstream end portion of the upstream link 132. A downstream end portion of the upstream link 132 may be understood to be an end portion of the upstream link 132 further or furthest (in the kinematic chain and/or relative to the upstream end portion) to the drive shaft 110.

In an example, the upstream link 132 is the first link on the interrupter unit side of the drive shaft 110. In an example, the upstream joint 134 is the first joint on the interrupter unit side of the drive shaft 110.

The phrase ‘interrupter unit side of the drive shaft’ may be understood as a side or end of the drive shaft 110, in the kinematic chain of the linkage mechanism, that is closer to the interrupter unit.

The phrase ‘first link’ or ‘first joint’ may be understood as the link or joint respectively that is closest or most proximate to the drive shaft 110, e.g. relative to other links or joints respectively in the linkage mechanism (on the interrupter unit side of the drive shaft).

Beneficially, by arranging the upstream link and the upstream joint closest to the drive shaft, the drive shaft can be arranged to obstruct the drive mechanism from reaching the kinematic singularity position.

### Closed-Position Angle and Obstructed-Position Angle

In an embodiment, a closed-position angle of the upstream joint 134 is at least 1 degree and/or at most 50 degrees. In an embodiment, the closed-position angle of the upstream joint 134 is more than 20 degrees and/or less than 30 degrees, for example 25 degrees (see FIG. 3).

The closed-position angle of the upstream joint 134 may be understood as an angle of the upstream joint 134 when the movable contact 122 is in the closed position.

When the closed-position angle of the upstream joint 134 is small, e.g. less than 45 degrees, the energy remaining in the kinematic chain as the movable contact nears the closed position is small, and the chance of parts impacting during closing is beneficially minimized.

When the closed-position angle is a finite angle from 0 degrees, e.g. more than 5 degrees, the circuit breaker is improved, in particular in respect of kinematic chain tolerances, for example in the linkage mechanism and drive mechanism dimensional tolerances, and drive unit energy tolerances.

In an embodiment, an obstructed-position angle of the upstream joint 134 is more than 0 degrees and/or less than 20 degrees, preferably more than 0 degrees and/or less than 10 degrees, for example 5 degrees (see FIG. 4).

The obstructed-position angle of the upstream joint 134 may be understood as the smallest angle the upstream joint 134 can reach or achieve before the drive shaft 110 acts as a stopper, i.e. before the drive shaft obstructs further movement of the linkage mechanism, more specifically before the downstream link 136 makes contact with or abuts the drive shaft 110.

When the upstream joint 134 is at the obstructed-position angle, it may be understood that the linkage mechanism 130 is obstructed (by the drive shaft 110) from reaching the kinematic singularity position (during the closing operation).

In an example, when the downstream link 136 makes contact with the drive shaft 110 or abuts the drive shaft 110, the upstream joint 134 is at the obstructed-position angle.

Beneficially, when the obstructed-position angle of the upstream joint 134 is more than 0 degrees, a margin to the kinematic singularity position is provided effectively precluding movement of the linkage mechanism through the kinematic singularity position.

Beneficially, when the obstructed-position angle of the upstream joint 134 is finite and small, e.g. more than 0 degrees and less than 20 degrees, even if there is an impact during closing, impact energy is small and damage to parts may be avoided.

In an embodiment, the closed-position angle of the upstream joint 134 is at least 1 degree more, preferably at least 5 degrees more than the obstructed-position angle of the upstream joint 134 (see FIGS. 3 and 4).

Beneficially, when a difference between the closed-position angle of the upstream joint 134 and the obstructed-position angle of the upstream joint 134 is finite, e.g. at least 1 degree, a clearance to the obstructed-position angle is provided and impact may be avoided.

### Angular Movement to Linear Movement Ratio

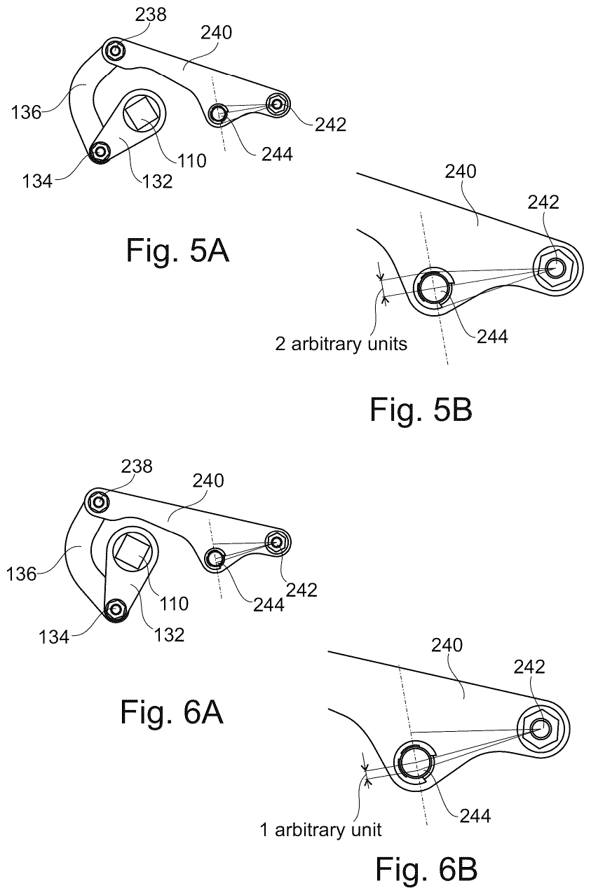

FIGS. 5A and 5B show the linkage mechanism in a position nearer to the open position, as described herein. In more detail, FIG. 5A shows the linkage mechanism having an angular displacement of about a third of the way from the open position, whilst FIG. 5B shows the effected linear displacement about 2 arbitrary units corresponding to the angular displacement of about a third of the way from the open position.

FIGS. 6A and 6B show the linkage mechanism in a position nearer to the closed position. In more detail, FIG. 6A shows the linkage mechanism having an angular displacement of about a third of the way from the closed position, whilst FIG. 6B shows the effected linear displacement about 1 arbitrary unit corresponding to the angular displacement of about a third of the way from the closed position.

In an embodiment, the linkage mechanism 130 is configured to transform a rotational movement of the drive shaft 110 to a linear movement of the movable contact 122 at a decreasing rate as the movable contact 122 approaches the closed position, i.e. when the movable contact 122 moves from the open position to the closed position.

In the example shown in FIGS. 5A to 6B, the first third of the angular displacement of rotation of the drive shaft 110 is transformed to about twice as much linear displacement of the actuation joint 244 thus of the movable contact 122 as compared to the last third of the angular displacement from the open position towards the closed position.

Accordingly, it may be understood from the example shown in FIGS. 5A to 6B and described herein that the linkage mechanism may be configured to transform rotational movement to linear movement at a decreasing rate as the movable contact 122 approaches the closed position.

In a further example, the linkage mechanism 130 may be configured to transform a rotational movement of the drive shaft 110 to a linear movement of the movable contact 122 at an increasing rate as the movable contact 122 approaches the open position, i.e. when the movable contact 122 moves from the closed position to the open position.

It can be readily appreciated that a decreasing linear displacement of the movable contact 122 per angular displacement of the drive shaft 110, as the movable contact 122 approaches the closed position and/or as the movable contact 122 moves from the open position to the closed position, can be achieved in different manners.

For example, the linkage mechanism 130 may include the upstream link 132, downstream link 136 and actuation link 240, a (revolute) upstream joint 134 rotatably coupling the upstream link 132 and downstream link 136, a (revolute) downstream joint 238 rotatably coupling the downstream link 136 and the actuation link 240.

In another example, the linkage mechanism 130 may include the upstream link 132 and the downstream link 136 (without the actuation link 240), whereby the movable contact 122 is coupled to the downstream link 136 via a (revolute) joint and a further joint is arranged on the downstream link 136 to anchor the downstream link 136 to a frame.

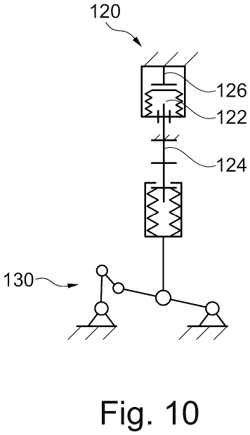

FIG. 10 shows a further example of how the linkage mechanism 130 may be realized. In more detail, the linkage mechanism 130 may be implemented using four bars as shown, each pair of bars being rotatably coupled. In the example shown, the anchored end seen on the left corresponds to the drive shaft. With the linkage mechanism 130 shown, a rotational movement of the drive shaft can be transformed to a linear movement of the movable contact 122.

When the movable contact 122 approaches the closed position, the two bars closest to the anchored end on the left move towards each other, and towards a kinematic singularity position. When the movable contact 122 is in the closed position, the two bars is close to the kinematic singularity position. In the example shown, the two bars would impact each other before the kinematic singularity position is reached, thus the linkage mechanism 130 obstructs itself from reaching the kinematic singularity position.

Beneficially, by providing a decreasing linear displacement per angular displacement when approaching closed position, several benefits are achieved including reduced force/energy and decelerating movement as the movable contact approaches the closed position, and further, less bounce and improved precision at stroke end i.e. as the movable contact arrives at the closed position, and still further, less fine-tuning of a contact spring is necessary, where a contact spring is arranged on the movable contact.

A contact spring may be understood as a spring that stores energy as the movable contact approaches the closed position, and is for example arranged on the movable contact, for slowing the movable contact down as the movable contact approaches the closed position and/or for providing a suitable force for maintaining the movable contact in the closed position and/or for providing energy for moving the movable contact during a breaking operation, in particular during a start of the breaking operation.

Further beneficially, a decreasing linear displacement per angular displacement when approaching closed position have further benefits including at least one of increased opening force/energy and accelerating movement as the movable contact moves from the closed position and improved weld breaking during opening and less fine-tuning of contact spring force (e.g. during installation of circuit breaker) necessary.

An opening spring may be understood as a spring that stores energy as the movable contact moves to the closed position and/or for supporting the movement of the movable contact from the closed position to the open position and/or for keeping the moveable contact in the open position.

### Actuation Link, Downstream Joint, Actuation Joint and Anchor Joint

FIGS. 2 and 3 show a linkage mechanism. Some further embodiments and examples including those relating to the actuation link, downstream joint, actuation joint and anchor joint are further described herein.

In an example, the downstream joint 238 is a revolute joint. In an example the downstream joint 238 couples the downstream link 136 to the movable contact 122, for example via the actuation link 240 and/or actuation joint 244.

In an example, the downstream joint 238 couples the downstream link 136 to the movable contact 122 via a movable contact stem 124 of the movable contact 122.

In an embodiment, the linkage mechanism 130 includes a rigid actuation link 240 rotatably coupled to the downstream link 136 via a downstream joint 238.

In an embodiment, the actuation link 240 is a lever.

The actuation link 240 may be understood to be rotatably coupled at an anchor joint 242, e.g. to a frame 150 and/or a housing of the circuit breaker 100.

The actuation link 240 may be rotatably coupled to the movable contact 122, e.g. to a movable contact stem 124 of the movable contact 122, via an actuation joint 244 arranged on the actuation link 240 between the downstream joint 238 and the anchor joint 242.

In an example, the actuation joint 244 coupling the actuation link 240 to the movable contact 122 is arranged closer to the anchor joint 242 than to the downstream joint 238.

Beneficially, the linkage mechanism has a mechanical torque advantage, when moving between the open position and the closed position, and further, a favourable distribution of reaction forces, in particular in the closed position, between the downstream joint 238 and the anchor joint 242, specifically less reaction force on the drive shaft (via the downstream and upstream links) relative to the reaction force on the frame (via the anchor joint).

Moreover, due to the actuation joint 244 being arranged on the actuation link 240 between the downstream joint 238 and the anchor joint 242, i.e. the downstream joint 238 and anchor joint 242 are on either side of the actuation joint 244, the linkage mechanism may be understood to be arranged around the movable contact(s) (as opposed to being arranged in a separate space). Beneficially, the linkage mechanism is compact.

Additionally, the actuation joint 244 being arranged closer to the anchor joint 242 than to the downstream joint 238, provides space for the drive shaft 110, i.e. the linkage mechanism is arranged tightly around the movable contact(s). Beneficially, the linkage mechanism is especially compact.

### Nominal Operating Angles in Linkage Mechanism

In an embodiment, a nominal operating angle of the upstream joint 134 is from 1 degree to 90 degrees, preferably from 2 degrees to 60 degrees.

In an embodiment, a nominal operating angle of the downstream joint 238 is from 30 degrees to 110 degrees, preferably from 35 degrees to 105 degrees, more preferably from 40 degrees to 100 degrees, and most preferably from 45 degrees to 95 degrees.

Beneficially, a particularly compact, reliable and safe linkage mechanism is provided.

The angle of the downstream joint 238 may be understood as an angle between a third line extending perpendicularly to a rotation axis of the drive shaft 110 (and/or perpendicularly to a rotation axis of the downstream joint 238) from the downstream joint 238 to the upstream joint 134 and a fourth line extending perpendicularly to the rotation axis of the drive shaft 110 (and/or perpendicularly to a rotation axis of the downstream joint 238) from the the downstream joint 238 to the anchor joint 242.

### Further Aspects of the Linkage Mechanism

It may be understood that the linkage mechanism 130 is configured to transmit a movement of the drive shaft 110 to a movement of the movable contact 122, and/or transform a rotational movement of the drive shaft 110 into a substantially/predominantly (e.g. more than 50% or more than 75% of displacement is linear or along a straight line) linear movement of the movable contact 122.

In general, a linkage mechanism may be configured to transmit a force from the drive unit to the interrupter unit. The linkage mechanism may be understood to be a mechanical linkage mechanism.

In an example, one or more or all of the upstream link 132, downstream link 136, actuation link 240, inner link 462, outer link 466 and operative link 470 is/are a rod(s) or a lever(s).

The rotatable drive shaft 110 may be understood to be configured to transfer an actuation force, in particular an actuation force for closing or opening, to the interrupter unit 120 particularly to the movable contact 122.

In an example, an upstream end portion of the rotatable drive shaft 110 is operatively coupled to the drive mechanism 460. In an example, a downstream end portion of the rotatable drive shaft 110 is operatively coupled to the linkage mechanism 130.

In an embodiment, the rotation axes of two or more, or all of the drive shaft 110, upstream joint 134, downstream joint 238, anchor joint 242 and actuation joint 244 are parallel.

Beneficially, due to the parallel movements, the components can be arranged next to each other and the linkage mechanism is especially compact.

In an embodiment, one or more or all of the upstream joint 134, downstream joint 238, anchor joint 242 and actuation joint 244 is/are revolute joint(s).

Beneficially, the kinematic chain of the linkage mechanism is planar.

In an embodiment, a material of the drive shaft 110 is metal. In an example, at least 80%, preferably at least 90% by mass of the drive shaft 110 is metal. In an example, a core of the drive shaft 110 is metal.

In an embodiment, a material of the upstream link 132 and/or the downstream link 136 is/are metal. In an example, at least 80%, preferably at least 90% by mass of the upstream link 132 and/or the downstream link 136 is/are metal. In an example, a core of the upstream link 132 and/or the downstream link 136 is/are metal.

Beneficially, in the closed position, due to the small angle of the upstream joint, thus reaction force being distributed more to shaft bending and reaction torque being correspondingly reduced, resulting in considerably better wear characteristic, thus better reliability, the drive shaft accordingly bears more bending. Accordingly, a metal drive shaft withstands bending well, and additionally has good torsion strength, which in combination with good bending strength of metal upstream link and/or downstream link, is particularly beneficial in respect of the high dynamic forces occurring during switching. Beneficially, the circuit breaker is safe and reliable.

In an embodiment, a material of the linkage mechanism 130 or movable contact assembly, for example of a component between the downstream link 136 and the movable contact 122, is electrically insulating for electrically insulating the drive shaft 110 from the movable contact 122.

In an embodiment, (when viewed in/from the direction of an axis of the drive shaft 110) when the movable contact 122 is in a closed position, the upstream joint 134, downstream joint 238 and actuation joint 244 form a triangle (in a plane perpendicular to the axis of the drive shaft 110), wherein the drive shaft 110 is arranged such that the axis of the drive shaft 110 is inside of/within the triangle. Beneficially a compact linkage mechanism is provided.

It may be understood that the linkage mechanism 130 is in an obstructed position when the downstream link 136 makes contact with or abuts the drive shaft 110.

In an embodiment, (when viewed in/from the direction of an axis of the drive shaft 110) the linkage mechanism 130 is in an obstructed position, a straight line joining the upstream joint 134 and the downstream joint 238 intersects with the drive shaft 110 (in a plane perpendicular to the axis of the drive shaft 110), wherein the downstream link 136 has a curved form such that the angle of the upstream joint 134 is finite and small, e.g. more than 0 degrees and less than 20 degrees.

In an example, the downstream link 136 has a concave portion arranged to face the drive shaft 110.

Beneficially, even if there is an impact during closing, impact energy is small and damage to parts may be avoided.

### Drive Mechanism

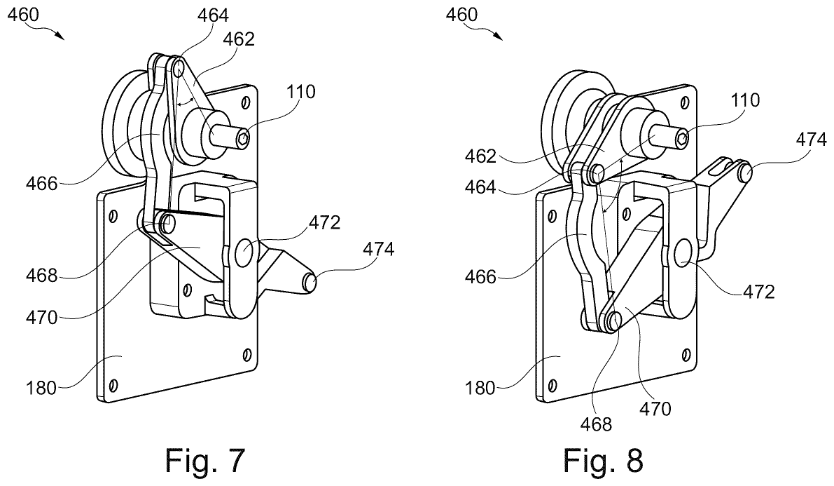

FIGS. 7 and 8 show the drive mechanism, specifically, when the movable contact is in the open position and in the closed position respectively, according to embodiments and examples described herein.

In an embodiment, the circuit breaker includes a drive mechanism 460 that includes at least two rigid links including an inner link 462 and an outer link 466 rotatably coupled to each other via an inner joint 464, the drive mechanism 460 being configured to transfer drive energy to the drive shaft 110 via at least the inner link 462, the outer link 466 and the inner joint 464.

In an embodiment, the drive mechanism 460 is configured to move towards a drive-kinematic singularity position when the movable contact 122 approaches the open position during an opening operation, wherein the kinematic singularity position of the drive mechanism 460 is defined by the inner joint 464 having an angle of 0 degrees between the inner link 462 and the outer link 466.

Beneficially, due to the drive mechanism moving towards the drive-kinematic singularity as the movable contact approaches the open position, the distribution of reaction forces in the drive mechanism, in particular the torque on the operative link 470 decreases.

In the open position, an opening spring may hold the moveable contact in the open position, and a reduced holding torque is beneficial.

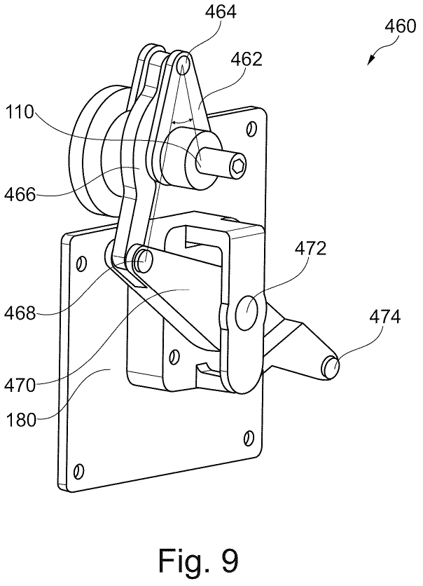

FIG. 9 shows the drive shaft obstructing the drive mechanism from reaching the drive-kinematic singularity position according to embodiments and examples described herein.

In an embodiment, the drive shaft 110 is arranged as a stopper for the drive mechanism 460 obstructing the drive mechanism 460 from reaching the drive-kinematic singularity position during the opening operation.

Beneficially, as the drive shaft itself obstructs the drive mechanism from reaching the kinematic singularity position, the drive mechanism is prevented from moving through the drive-kinematic singularity position and becoming destroyed and/or stuck.

In combination with configuring the drive mechanism to move towards drive-kinematic singularity, whereby static wear is greatly reduced and the circuit breaker is safer and more reliable, using the drive shaft to prevent the drive mechanism from moving through the drive-kinematic singularity results in a much safer and much more reliable mechanism that handles large dynamic forces during movement towards the drive-kinematic singularity.

That is, the safe and reliable benefit is greatly compounded by the combination of both moving towards drive-kinematic singularity and the drive shaft arranged as a stopper for the drive mechanism.

Moreover, the drive shaft being arranged as a stopper for the drive mechanism is particularly space efficient and simple, as the drive mechanism itself obstructs itself from reaching the drive-kinematic singularity position.

Beneficially, the drive mechanism is safe and reliable without increased complexity and increased number of components, particularly when high forces (e.g. 1 to 100 kN) and fast switching (e.g. 1 to 1000 ms) occurs during opening. For example, a linear speed of the moveable contact 122, e.g. during opening or closing, may be from 0.3 m/s to 10 m/s, or more specifically between 0.5 m/s and 3 m/s. In another example, the peak force, e.g. during opening or closing, e.g. on or at the actuation joint 244, may be from 1 kN to 100 kN.

### Inner Joint and Angle of Inner Joint

The angle of the inner joint 464 may be understood as an angle between a first drive line extending perpendicularly to a rotation axis of the drive shaft 110 (and/or perpendicularly to a rotation axis of the inner joint 464) from the inner joint 464 to the drive shaft 110 and a second drive line extending perpendicularly to the rotation axis of the drive shaft 110 (and/or perpendicularly to a rotation axis of the inner joint 464) from the inner joint 464 to the outer joint 468.

In an embodiment, the outer joint 468 is arranged on the outer link 466 and/or operably couples a motion of the outer link 466 to a drive unit (not shown).

The angle of the inner joint 464 may be understood as an angle in a plane perpendicular to the rotation axis of the inner joint 464 and/or a plane perpendicular to the rotation axis of the drive shaft 110.

The angle of the inner joint 464 may be understood to be an angle between a first drive line joining the inner joint 464 and the outer joint 468, and a second drive line joining the inner joint 464 and the drive shaft 110 for example at a point of coupling of the drive shaft 110 with the inner link 462.

The angle of the inner joint 464 may be understood to be an angle between a first radially extending drive line and a second radially extending drive line, the first radially extending drive line extending from a centre of the inner joint 464 to a centre of the drive shaft 110 and the second radially extending drive line radially extending from a centre of the inner joint 464 to a centre of the outer joint 468.

### Drive-Kinematic Singularity Position

The drive mechanism 460 may be understood to be in the drive-kinematic singularity position when the first line and the second line are collinear and/or when an angle of the inner joint 464 is 0 degrees.

A drive-kinematic singularity position of the drive mechanism 460 may be understood to correspond to a maximum in the ratio of (transmittable/transmitting) torque in the drive shaft 110 to angular velocity of the inner joint 464.

A kinematic singularity position of the linkage mechanism 130 may be understood to correspond to a minimum in the ratio of a torque (transmittable/transmitted) by the inner link 462 on the drive shaft 110 to a bending force by the inner link 462 on the drive shaft 110.

It may be understood that a drive-kinematic singularity position of the drive mechanism is described herein for supporting understanding of what is prevented, and the drive-kinematic singularity position is not actually reachable by the drive mechanism as described herein, due to the drive mechanism being obstructed (by the drive shaft) from reaching the drive-kinematic singularity position.

### Inner Link and Outer Link

In an embodiment, the inner link 462 is a lever coupled in a non-rotatable manner to the drive shaft 110 at a driving end portion of the inner link 462. A driving end portion of the inner link 462 may be understood to be an end portion of the inner link 462 closer or closest (in the kinematic chain and/or relative to the driven end portion of the inner link 462) to the drive shaft 110.

In an embodiment, the inner link 462 is rotatably coupled via the inner joint 464 to the outer link 466 at a driven end portion of the inner link 462. A driven end portion of the inner joint 464 may be understood to be an end portion of the inner joint 464 further or furthest (in the kinematic chain and/or relative to the driving end portion of the inner link 462) to the drive shaft 110.

In an example, the inner link 462 is the first link on the drive unit side of the drive shaft 110. In an example, the inner joint 464 is the first joint on the drive unit side of the drive shaft 110.

The phrase ‘drive unit side of the drive shaft’ may be understood as a side or end of the drive shaft 110, in the kinematic chain of the drive mechanism, that is closer to a drive unit (not shown).

The phrase ‘first link’ or ‘first joint’ may be understood as the link or joint respectively that is closest or most proximate to the drive shaft 110, e.g. relative to other links or joints respectively in the drive mechanism (on the drive unit side of the drive shaft).

### Open-Position Angle and Blocked-Position Angle

In an embodiment, an open-position angle of the inner joint 464 is at least 1 degree and/or at most 50 degrees. In an embodiment, the open-position angle of the inner joint 464 is at least 5 degrees and/or at most 40 degrees. In an illustrative example, the open-position angle of the inner joint 464 is 25 degrees (see e.g. FIG. 7).

The open-position angle of the inner joint 464 may be understood as an angle of the inner joint 464 when the movable contact 122 is in the open position.

When the open-position angle of the inner joint 464 is small, e.g. less than 45 degrees, the energy remaining in the kinematic chain as the movable contact nears the open position is small, and the chance of parts impacting during opening is beneficially minimized.

When the open-position angle is a finite angle from 0 degrees, e.g. more than 5 degrees, the circuit breaker is improved, in particular in respect of kinematic chain tolerances, for example in the linkage mechanism and drive mechanism dimensional tolerances, and drive unit energy tolerances.

In an embodiment, a blocked-position angle of the inner joint 464 is at least 1 degree and/or at most 50 degrees. In an illustrative example, the blocked-position angle of the inner joint is 5 degrees (see e.g. FIG. 9).

The blocked-position angle of the inner joint 464 may be understood as the smallest angle the inner joint 464 can reach or achieve before the drive shaft 110 acts as a stopper, i.e. before the drive shaft obstructs further movement of the drive mechanism, more specifically before the inner link 462 makes contact with or abuts the drive shaft 110.

When the inner joint 464 is at the blocked-position angle, it may be understood that the drive mechanism 460 is obstructed (by the drive shaft 110) from reaching the drive-kinematic singularity position (during the opening operation).

In an example, when the inner link 462 makes contact with the drive shaft 110 or abuts the drive shaft 110, the inner joint 464 is at the blocked-position angle.

Beneficially, when the blocked-position angle of the inner joint 464 is more than 0 degrees, a margin to the drive-kinematic singularity position is provided effectively precluding movement of the drive mechanism through the kinematic singularity position.

Beneficially, when the blocked-position angle of the inner joint 464 is finite and small, e.g. more than 0 degrees and less than 20 degrees, even if there is an impact during opening, impact energy is small and damage to parts may be avoided.

In an embodiment, the open-position angle of the inner joint 464 is at least 1 degree more, preferably at least 5 degrees more than the blocked-position angle of the upstream joint 134 (see FIGS. 7 and 9).

Beneficially, when a difference between the closed-position angle of the upstream joint 134 and the obstructed-position angle of the upstream joint 134 is finite, e.g. at least 1 degree, a clearance to the obstructed-position angle is provided and impact may be avoided.

### Drive Unit

It may be understood that a drive unit may be configured to drive a rotation of the drive shaft 110, in particular for moving the movable contact 122 between the closed position and open position.

In an example, a drive unit may include a closing actuator for driving the drive shaft 110 to move the movable contact from the open position towards the closed position.

In an example, a drive unit may include an opening spring or opening actuator for driving the drive shaft 110 to move the movable contact from the closed position towards the open position.

In general, a drive unit may be realized as a mechanical spring and/or an electromagnetic actuator. Beneficially, a force applied by hand, for example in the range of 0.1 to 100 N is reinforced or augmented by the drive unit. In an example, a drive unit may provide energy of at least 50 J and/or at most 500 J.

### Operative Link, Outer Joint, Operative Joint and Support Joint

FIGS. 7 and 8 show a drive mechanism. Some further embodiments and examples including those relating to the operative link, outer joint, drive joint and support joint are further described herein.

In an example, the outer joint 468 is a revolute joint. In an example the outer joint 468 couples the outer link 466 to a drive unit (not shown), for example via the operative link 470 and/or operative joint 474.

In an example, the outer joint 468 couples the outer link 466 to a drive unit via a pushrod of the drive unit.

In an embodiment, the drive mechanism 460 includes a rigid operative link 470 rotatably coupled to the outer link 466 via a outer joint 468.

In an embodiment, the operative link 470 is a lever.

The operative link 470 may be understood to be rotatably coupled at a support joint 472, e.g. to a support 180 and/or to a housing of the circuit breaker 100.

The operative link 470 may be rotatably coupled to a drive unit, e.g. to a pushrod of the drive unit, via an operative joint 474 arranged on the operative link 470. In an example, the drive mechanism 460 and/or the operative link 470 is configured to be driven by a source of actuation energy.

### Further Aspects of the Drive Mechanism

In an embodiment, the rotation axes of two or more, or all of the drive shaft 110, inner joint 464, outer joint 468, support joint 472 and operative joint 474 are parallel.

Beneficially, due to the parallel movements, the components can be arranged next to each other and the drive mechanism is especially compact.

In an embodiment, one or more or all of the inner joint 464, outer joint 468, support joint 472 and operative joint 474 is/are revolute joint(s).

Beneficially, the kinematic chain of the drive mechanism is planar.

In an embodiment, a material of the inner link 462 and/or the outer link 466 is/are metal. In an example, at least 80%, preferably at least 90% by mass of the up inner link 462 and/or the outer link 466 is/are metal. In an example, a core of the inner link 462 and/or the outer link 466 is/are metal.

Beneficially, a metal drive shaft in combination with good bending strength of metal inner link 462 and/or outer link 466, is particularly beneficial in respect of the high dynamic forces occurring during switching. Beneficially, the circuit breaker is safe and reliable.

### Nominal Operating Angles in the Drive Mechanism

In an embodiment, a nominal operating angle of the inner joint 464 is at least 2 degrees and/or at most 130 degrees, preferably at least 5 degrees and/or at most 120 degrees.

In an embodiment, a nominal operating angle of the outer joint 468 is at least 40 degrees and/or at most 130 degrees, preferably at least 45 degrees and/or at most 120 degrees.

Beneficially, a particularly compact, reliable and safe drive mechanism is provided.

The angle of the outer joint 468 may be understood as an angle between a third line extending perpendicularly to a rotation axis of the drive shaft 110 (and/or perpendicularly to a rotation axis of the outer joint 468) from the outer joint 468 to the inner joint 464 and a fourth line extending perpendicularly to the rotation axis of the drive shaft 110 (and/or perpendicularly to a rotation axis of the outer joint 468) from the outer joint 468 to the support joint 472.

### Further Aspects Relating to the Interrupter Unit

It may be understood that the interrupter unit 120, in particular the movable contact 122 may be configured to be actuated via the linkage mechanism 130.

In an example, the interrupter unit 120, in particular the movable contact 122, includes a movable contact stem 124 actuatably/mechanically coupled at a linkage end to the linkage mechanism 130, for example via the actuation joint 244, and/or at a contact end to the movable contact 122.

The movable contact stem 124 may be configured to receive an actuation motion or force transmitted by the linkage mechanism 130 to move the movable contact 122.

It may be understood that the interrupter unit 120 is a vacuum interrupter unit. In an example, the interrupter unit 120 includes a vacuum chamber within which the movable contact 122 and the stationary contact 126 are at least partially arranged. In an example, the movable contact 122 and the stationary contact 126 are at least partially arranged in an enclosure of the interrupter unit 120 configured to maintain a vacuum condition.

It may be understood that the vacuum condition is configured for extinguishing an arc, when the movable contact 122 is moving from the closed position to the open position, and/or for preventing a current from forming in a contact gap between the movable contact 122 and the stationary contact 126.

### Further Aspects of the Circuit Breaker

Generally, a circuit breaker may comprise an actuation signal module, a drive unit, a linkage mechanism and an interrupter unit.

In general, an actuation signal module may be configured to receive manual input, e.g. via one or more pushbuttons, and/or automatic input, e.g. via some actuator. An actuation signal module may be configured to cause the drive unit to apply an actuation force and/or torque to the linkage mechanism. Beneficially, the circuit breaker is operable, e.g. via a pushbutton, to perform a make/break operation.

More generally, it may be understood that a circuit breaker is a device adapted to control and protect the grid, in particular to interrupt a short circuit current. According to an aspect, a circuit breaker may be a medium-voltage circuit breaker and/or a vacuum circuit breaker.

In an example, it may be understood that a circuit breaker as described herein is rated for operating with voltages in excess of 1 kV. For example, the circuit breaker may be a medium-voltage circuit breaker and/or rated to operate at voltages in the range of 1 kV to 72 kV, preferably in the range of 10 kV to 42 kV.

In an example, it may be understood that a circuit breaker as described herein is rated for operating with a nominal current of more than of 100 A, preferably at least 400 A and/or at most 5000 A, and/or a short-circuit current in excess of 10 kA rms, preferably at least 14 kA rms and/or at most 50 kA rms (a high short-circuit current load).

In an embodiment, the circuit breaker includes a gas-tight housing. In an embodiment the gas-tight housing is filled or configured to be filled with a dielectric medium.

In an embodiment, the dielectric medium of the gas-tight housing and/or of the circuit breaker is a dielectric gas having a global warming potential less than that of SF6. In an example, the dielectric medium is air, dry air, N2, CO2 or mixture of two or three of N2, O2, and CO2. In an example, the dielectric medium is a mixture of air, fluoroketones and/or AirPlus™. In an embodiment, the dielectric medium is a mixture of air and/or fluoroketones.

In an embodiment, the linkage mechanism 130 and vacuum interrupter unit 120 are arranged inside of a gas-tight housing of the circuit breaker 100. Beneficially, dielectric safety is improved.

In an embodiment, the drive mechanism 460 and/or drive unit are arranged outside of a gas-tight housing of the circuit breaker 100. Beneficially, improved access is provided.

While a interrupter unit including a movable contact and a stationary contact is described herein, a circuit breaker as described herein may be understood to comprise a plurality of interrupter units, in particular 3 interrupter units, each including a movable contact and a stationary contact respectively. Beneficially, a multiphase circuit breaker is provided, in particular a circuit breaker for a 3 phase electrical circuit/network.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practising the claimed invention, from a study of the drawings, the disclosure, and the appended claims.

In the claims, the word “comprising” does not exclude other elements, and the indefinite article “a” or “an” does not exclude a plurality. A single element or other unit may fulfill the functions of several items recited in the claims. The mere fact that certain features are recited in mutually different embodiments or in dependent claims does not indicate that a combination of these features cannot be used to advantage. The scope of protection of the present application covers any possible combination of features recited in the various embodiments or in the dependent claims, without departing from the spirit and scope of the application. Reference signs in the claims shall not be construed as limiting the scope of the invention.

1. A medium-voltage vacuum circuit breaker comprising:
a rotatable drive shaft;
a vacuum interrupter unit; and
a linkage mechanism linking the drive shaft to the vacuum interrupter unit;
wherein the vacuum interrupter unit comprises a movable contact and a stationary contact, the movable contact being movable between a closed position and an open position along an axis of the movable contact and including a movable contact stem;
wherein the linkage mechanism includes at least two rigid links including an upstream link and a downstream link rotatably coupled to each other via an upstream joint, the linkage mechanism being configured to be driven by the drive shaft and to transform a rotational movement of the drive shaft to a linear movement of the movable contact along the axis of the movable contact via at least the upstream link, the upstream joint and the downstream link;
wherein the linkage mechanism is configured to move towards a kinematic singularity position as the movable contact approaches the closed position during a closing operation, wherein the kinematic singularity position of the linkage mechanism is defined by an angle of the upstream joint being 0 degrees, the angle of the upstream joint being between the upstream link and the downstream link; and
wherein the drive shaft is arranged as a stopper for the linkage mechanism, obstructing the linkage mechanism from reaching the kinematic singularity position during the closing operation.

2. The circuit breaker according to claim 1, wherein the angle of the upstream joint is an angle between a first line extending perpendicularly to a rotation axis of the drive shaft from the upstream joint to the drive shaft and a second line extending perpendicularly to the rotation axis of the drive shaft from the upstream joint to the downstream joint, wherein the downstream joint is arranged on the downstream link and operably couples a motion of the downstream link to a motion of the movable contact.

3. The circuit breaker according to claim 1, wherein the upstream link is a lever coupled in a non-rotatable manner to the drive shaft at an upstream end portion of the upstream link, wherein the upstream link is rotatably coupled via the upstream joint to the downstream link at a downstream end portion of the upstream link.

4. The circuit breaker according to claim 3, wherein a closed-position angle of the upstream joint is at least one of at least 1 degree or at most 50 degrees.

5. The circuit breaker according to claim 1, wherein the linkage mechanism is configured to transform a rotational movement of the drive shaft to a linear movement of the movable contact at a decreasing rate as the movable contact approaches the closed position.

6. The circuit breaker according to claim 1, wherein the linkage mechanism comprises a rigid actuation link rotatably coupled to the downstream link via a downstream joint.

7. The circuit breaker according to claim 6, wherein the actuation link is a lever rotatably coupled at an anchor joint, the actuation link being rotatably coupled to the movable contact via an actuation joint arranged on the actuation link between the downstream joint and the anchor joint.

8. The circuit breaker according to claim 1, wherein rotation axes of two or more of the drive shaft, upstream joint, downstream joint, anchor joint and actuation joint are parallel.

9. The circuit breaker according to claim 1, further comprising a drive mechanism including at least two rigid links including an inner link and an outer link rotatably coupled to each other via an inner joint, the drive mechanism being configured to transfer drive energy to the drive shaft via at least the inner link, the outer link and the inner joint,
wherein the drive mechanism is configured to move towards a drive-kinematic singularity position when the movable contact approaches the open position during an opening operation, wherein the kinematic singularity position of the drive mechanism is defined by the inner joint having an angle of 0 degrees between the inner link and the outer link; and
wherein the operating shaft is arranged as a stopper for the drive mechanism obstructing the drive mechanism from reaching the drive-kinematic singularity position during the opening operation.

10. The circuit breaker according to claim 9, wherein the drive mechanism comprises a rigid operative link rotatably coupled to the outer link via an outer joint, preferably wherein the operative link is rotatably coupled at a support joint to a support or to a housing of the circuit breaker, the operative link being configured to be driven by a source of actuation energy.

11. The circuit breaker according to claim 1, wherein the linkage mechanism and vacuum interrupter unit are arranged inside of a gas-tight housing of the circuit breaker.

12. The circuit breaker according to claim 1, wherein a material of the drive shaft is metal.

13. The circuit breaker according to claim 1, wherein a nominal operating angle of the upstream joint is from 1 degree to 90 degrees.

14. The circuit breaker according to claim 1, wherein a nominal operating angle of the downstream joint is from 30 degrees to 110 degrees, preferably from 40 degrees to 100 degrees.

15. The circuit breaker according to claim 11, wherein the gas-tight housing is filled with a dielectric gas having a global warming potential less than that of SF6.

16. The circuit breaker according to claim 12, wherein a material of a core of the drive shaft is metal.

17. The circuit breaker according to claim 13, wherein the nominal operating angle of the upstream joint is from 2 degrees to 60 degrees.

18. The circuit breaker according to claim 14, wherein the nominal operating angle of the downstream joint is from 40 degrees to 100 degrees.
